(19) United States
(12) Patent Application Publication
(10) Pub. No.: US 2011/0220572 A1
(43) Pub. Date: Sep. 15, 2011

(54) FILTERING SYSTEM AND METHOD

(75) Inventor: Kwang-Jin Lee, Gyeonggi-do (KR)

(73) Assignee: KOLON INDUSTRIES, INC., Kwacheon-si, Kyunggi-do (KR)

(21) Appl. No.: 13/129,328

(22) PCT Filed: Nov. 5, 2009
(86) PCT No.: PCT/KR2009/006478

§ 371 Date: May 27, 2011

(30) Foreign Application Priority Data
Nov. 14, 2008 (KR) 10-2008-0113231
Nov. 4, 2009 (KR) 10-2009-0105868

(51) Int. Cl. B01D 65/02; C02F 1/44

(52) U.S. Cl. 210/636; 210/177; 210/139; 210/143; 210/149; 210/151

(57) ABSTRACT

Disclosed is a filtering system and method which facilitates to maximize cleaning efficiency, minimize heat energy consumption for cleaning, and shorten cleaning time by a concentrated heating only in a filtering membrane for a maintenance cleaning or recovery cleaning, wherein the filtering system comprises a membrane module including a filtering membrane; an air supplying means for cleaning the filtering membrane; and a heater for heating air supplied from the air supplying means.

### TECHNICAL FIELD

The present invention relates to a filtering system and method, and more particularly to a filtering system and method which facilitates to maximize cleaning efficiency, minimize heat energy consumption for cleaning, and shorten cleaning time by a concentrated heating only in a filtering membrane for a maintenance cleaning or recovery cleaning.

### BACKGROUND ART

A separation method using a membrane has lots of advantages over the method based on heating or phase-changing. Among the advantages is high reliability of water treatment since the water purity required can be easily and stably satisfied by adjusting the size of the pores of a membrane. Furthermore, since the separation method using a membrane does not require a heating process, a membrane can be used with microorganism which is useful for separation process but may be adversely affected by heat.

One kind of the hollow fiber membrane modules is a suction type hollow fiber membrane module (or may also be referred to as an internal pressure type hollow fiber membrane module) which is submerged into a water tank filled with fluid to be treated. Negative pressure is applied to the inside of the hollow fiber membranes, whereby only fluid passes through the wall of each membrane and solid elements such as impurities and sludge are rejected. This suction type hollow fiber membrane module is advantageous in that the manufacturing cost is relatively low and that the installation and maintenance cost is reduced since a facility for circulating fluid is not required. However, the suction type hollow fiber membrane module has a disadvantage of the limitation on flux per unit period.

In opposition to the suction type hollow fiber membrane module, there is an external pressure type hollow fiber membrane module. In case of the external pressure type hollow fiber membrane module, external pressure is applied to fluid to be treated so that only fluid passes through the wall of each membrane and solid elements such as impurities and sludge are rejected. Even though the external pressure type hollow fiber membrane module necessarily requires a facility for circulating fluid, a flux per unit period in the external pressure type hollow fiber membrane module is relatively larger than a flux per unit period in the suction type hollow fiber membrane module.

When the fluid in which contaminants including solid elements are suspended is filtered through the use of filtering membrane module, the filtering membrane might be easily contaminated due to the contaminants, thereby causing low water permeability of the filtering membrane. Thus, it is necessary to regularly clean the filtering membrane by removing the contaminants from therefrom. According to a cleaning purpose, a method for cleaning the contaminated filtering membrane may be largely classified into a maintenance cleaning and a recovery cleaning.

A main purpose of the maintenance cleaning is to maintain good permeation performance of filtering membrane. The maintenance cleaning is mainly performed via physical cleaning such as backwashing process or aeration process during a water treatment or after a temporary stoppage of water treatment. The physical cleaning may be classified into a backwashing process and an aeration process. The backwashing process removes impurities from a surface of membrane by causing air or water to flow backward through the membrane during a temporary stoppage of water treatment. The aeration process removes impurities from a surface of membrane by generating rising air bubbles through air jetted from an aeration pipe positioned under the membrane, and causing the rising and circulation of water filled in a water-treatment tank.

The recovery cleaning is performed when the filtering membrane module exhibits serious deterioration in permeation performance of a membrane due to contaminants accumulated by a long-term use in the water-treatment tank. A main purpose of the recovery cleaning is to recover permeation performance of the membrane.

Typically, the recovery cleaning is to clean the filtering membrane through the use of chemical cleaning agent, for example, acid solution such as HCl, NHO₃, or citric acid or the like and/or alkaline solution such as NaOH or NaOCl or the like. The recovery cleaning is performed by completely discharging feed water filled in the water-treatment tank, and carrying out the chemical cleaning through the sequential supply of the alkaline and acid solutions into the water-treatment tank. Before this chemical cleaning, a flushing process for the filtering membrane module may be performed. Selectively, the recovery cleaning may be carried out in an additional cleaning bath.

Efficiency of the maintenance cleaning and recovery cleaning is highly related with a temperature of the filtering membrane. That is, as a surface temperature of the filtering membrane becomes higher, the cleaning efficiency is improved more. Thus, it is preferable that the surface temperature of the filtering membrane be increased during the maintenance cleaning and recovery cleaning. When the feed water to be treated is heated to a predetermined temperature, and the heated feed water is supplied to the filtering membrane module, it is possible to enhance the efficiency of the maintenance cleaning. When the chemical cleaning solution for the recovery cleaning is heated to a predetermined temperature, and is then supplied to the filtering membrane module, it allows the improved efficiency of the recovery cleaning.

However, even though it needs to increase the surface temperature of only the filtering membrane, the related art method needs to entirely heat the feed water or chemical cleaning solution, which inevitably causes an excessive loss of heat energy. Especially, since the feed water or chemical cleaning solution is exposed to the atmosphere, the heat may be seriously lost in the winter season.

### DISCLOSURE

### Technical Problem

Therefore, the present invention is directed to a filtering system and method that substantially obviates one or more of the problems due to limitations and disadvantages of the related art.

An aspect of the present invention is to provide a filtering system and method which facilitates to maximize cleaning efficiency and minimize heat energy for a cleaning process by concentratedly heating only filtering membrane for a maintenance cleaning or recovery cleaning.

Another aspect of the present invention is to provide a filtering system and method which facilitates to shorten cleaning time by concentratedly heating only filtering membrane for a maintenance cleaning or recovery cleaning.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, a filtering system comprises a membrane module including a filtering membrane; an air supplying means for cleaning the filtering membrane; and a heater for heating air supplied from the air supplying means.

In another aspect of the present invention, a filtering method comprises performing a water treatment by the use of membrane module including a filtering membrane; providing air for cleaning the filtering membrane; heating the air; and providing the heated air to the filtering membrane.

It is to be understood that both the foregoing general description and the following detailed description are exemplary and explanatory and are intended to provide further explanation of the invention as claimed.

### ADVANTAGEOUS EFFECTS

According to a filtering system and method of the present invention, only filtering membrane is concentratedly heated for a maintenance cleaning or recovery cleaning of the filtering membrane, thereby maximizing cleaning efficiency, and simultaneously minimizing heat energy consumption for the cleaning.

Also, only filtering membrane is concentratedly heated for a maintenance cleaning or recovery cleaning of the filtering membrane, whereby it is possible to shorten cleaning time for the filtering membrane.

### DESCRIPTION OF DRAWINGS

FIG. 1 illustrates an exemplary external pressure type hollow fiber membrane module.

FIG. 2 is a schematic view illustrating a filtering system using an external pressure type hollow fiber membrane module according to the present invention.

FIG. 3 is a schematic view illustrating a submerged-type hollow fiber membrane module.

FIG. 4 is a schematic view illustrating a filtering system using a submerged-type hollow fiber membrane module according to the present invention.

FIG. 5 illustrates a recovery cleaning of a hollow fiber membrane module by the use of filtering system according to the present invention.

FIG. 6 is a block diagram illustrating an operation of a heater according to an embodiment of the present invention.

### BEST MODE

Reference will now be made in detail to the preferred embodiments of the present invention, examples of which are illustrated in the accompanying drawings. Wherever possible, the same reference numbers will be used throughout the drawings to refer to the same or like parts.

Hereinafter, a filtering system and method according to the present invention will be described with the accompanying drawings.

For the following description of the present invention, a filtering membrane module is illustrated as a hollow fiber membrane module, but it is not limited to this type. For example, the present invention may be applied to various kinds of filtering membrane modules including a flat-type module as well as the hollow fiber membrane module.

The technical idea of the present invention can be identically applied to both a through-both-ends water collection type and a through-one-end water collection type, wherein the through-both-ends water collection type uses two headers so as to collect permeates from both ends of a hollow fiber membrane, and the through-one-end water collection type uses one header so as to collect permeates from one end of a hollow fiber membrane.

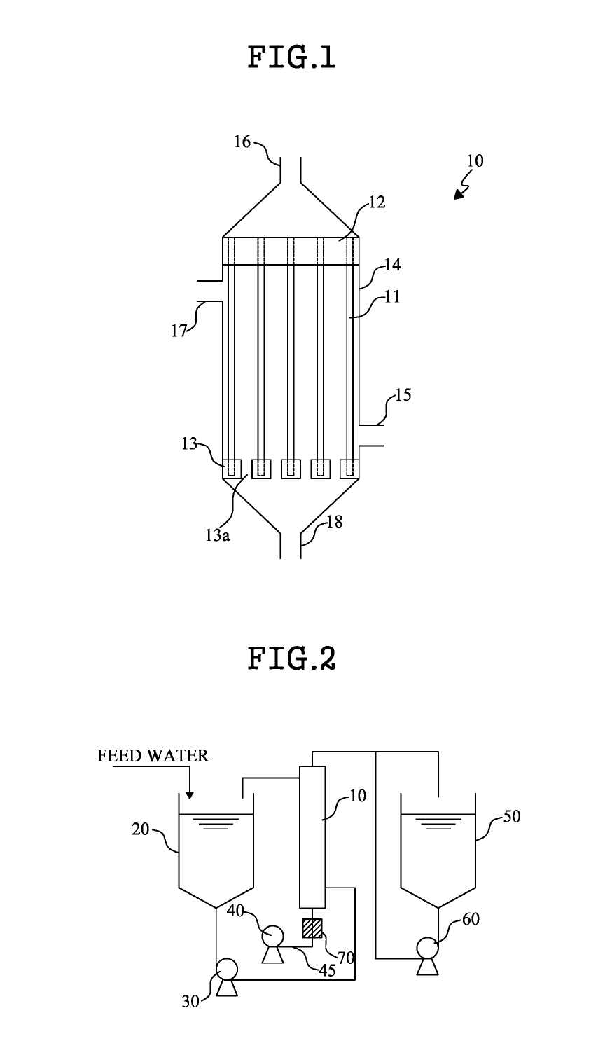

FIG. 1 illustrates an exemplary external pressure type hollow fiber membrane module. FIG. 2 is a schematic view illustrating a filtering system using an external pressure type hollow fiber membrane module according to the present invention.

The external pressure type hollow fiber membrane module 10 includes a plurality of hollow fiber membranes 11, wherein each hollow fiber membrane 11 has such a hollow as to enable the permeation of fluid from an external surface to an internal surface of each membrane 11. The plurality of hollow fiber membranes 11 are grouped into bundles, wherein longitudinal directions of the respective hollow fiber membranes 11 are provided in parallel.

At least one end of each of the hollow fiber membranes is potted into a first potting portion 12. Then, the first potting portion 12 is cut together with the plurality of hollow fiber membranes 11 so as to make an open end in each of the plurality of hollow fiber membranes 11.

The first potting portion 12 may be made of thermosetting resin, for example, epoxy resin, urethane resin, or silicon rubber. Selectively, the thermosetting resin may be mixed with filler such as silica, carbon black, or carbon fluoride so as to enhance strength of the first potting portion 12 and simultaneously reduce setting shrinkage of the first potting portion 12.

The other end of each hollow fiber membrane 11 is potted into a second potting portion 13. A material used for the second potting portion 13 may be the same as or different from a material used for the first potting portion 12. Selectively, instead of potting the other end of each hollow fiber membrane 11, the other end of each hollow fiber membrane 11 may be sealed by thermosetting resin.

A plurality of openings 13a are provided in the second potting portion 13 so that air for aeration cleaning is uniformly supplied to the hollow fiber membranes 11.

The first potting portion 12 having the plurality of hollow fiber membranes 11 potted thereinto is fixedly adhered to an inner surface of a module case 14 by a sealant, whereby it is possible to prevent permeates sequentially flowing into the hollow through the hollow fiber membrane 11 and being discharged through the open end of the hollow fiber membrane 11 from being mixed with feed water to be treated.

The feed water to be treated is introduced into the module case 14 through a feed-water inlet port 15. Then, the feed water introduced into the module case 14 is pressurized by a pump, whereby some of the feed water permeates through the hollow fiber membrane 11 and then flows into the hollow of the hollow fiber membrane 11. Thus, permeates permeating through the hollow fiber membrane 11 are discharged to the external through a permeated-water outlet port 16 of the module case 14. Also, the feed water (hereinafter, referred to as “concentrated water”) whose concentration of solid elements such as impurities and sludge becomes higher due to the discharge of permeates is discharged to the external through a concentrated-water outlet port 17.

During the filtering process, air for cleaning the hollow fiber membrane 11 is supplied to the inside of the module case 14 through an air inlet port 18.

Selectively, both the feed water to be treated and the air for cleaning the hollow fiber membrane 11 may be supplied to the inside of the module case 14 through one inlet port 18. In this case, both the feed water to be treated and the air for the aeration cleaning flow to the hollow fiber membrane through the plurality of openings 13a provided in the second potting portion 13.

As shown in FIG. 2, the feed water to be treated is transferred to a circulation tank 20, and is then transferred to the hollow fiber membrane module 10 through a pipe by a feed-water supplying pump 30. Thereafter, permeates permeating through the hollow fiber membrane 11 are transferred to a permeate tank 50, and the concentrated water is again transferred to the circulation tank 20.

In order to carry out a backwashing process for the hollow fiber membrane 11 after stopping the filtering process, permeates stored in the permeate tank 50 is transferred to the hollow fiber membrane module 10 by a backwashing pump 60. Also, compressed air is injected into the inside of the hollow fiber membrane module 10 by the air inlet port 18 through the use of air supplying means 40, to thereby carry out the aeration cleaning of the hollow fiber membrane 11. In this case, the air supplying means 40 may be a blower or air compressor, but not necessarily. The air supplying means 40 may be formed in any shape enabling to supply the air.

According to the present invention, the air discharged from the air supplying means 40 is supplied to the external pressure type hollow fiber membrane module 10 through a pipe 45, wherein the pipe 45 is heated by a heater 70. As the pipe 45 is heated by the heater 70, the air passing through the pipe 45 is also heated. The heated air is guided via the pipe 45, and is injected into the inside of the external pressure type hollow fiber membrane module 10, whereby the temperature adjacent to the hollow fiber membrane 11 is raised concentratedly.

Thus, there is the temperature difference between the feed water positioned adjacent to the hollow fiber membrane and the feed water positioned in the other portions, whereby the heat energy can be saved by the temperature difference. For example, there is no meaningful difference between the cleaning effect of the hollow fiber membrane 11 obtained when the feed water heated to 40° C. is transferred to the hollow fiber membrane module 10, and the cleaning effect of the hollow fiber membrane 11 obtained when the feed water heated to 10° C. is transferred to the hollow fiber membrane module 10 under the circumstance that the feed water positioned adjacent to the hollow fiber membrane 11 is selectively heated to 40° C. However, in consideration for the energy consumption, in comparison with the heat energy required for heating all the feed water to be transferred to the hollow fiber membrane module at 40° C., the heat energy required for selectively heating the feed water positioned adjacent to the hollow fiber membrane 11 at 40° C. is largely decreased so that the energy consumption is reduced by the difference of energy required.

According to an embodiment of the present invention, the heater 70 includes a heating wire wound on the pipe 45, but it is not limited to the heating wire. Instead of the heating wire, it is possible to provide any shape capable of heating the pipe 45. For example, the heater 70 may heat the air passing through the pipe 45 by the use of heating fluid.

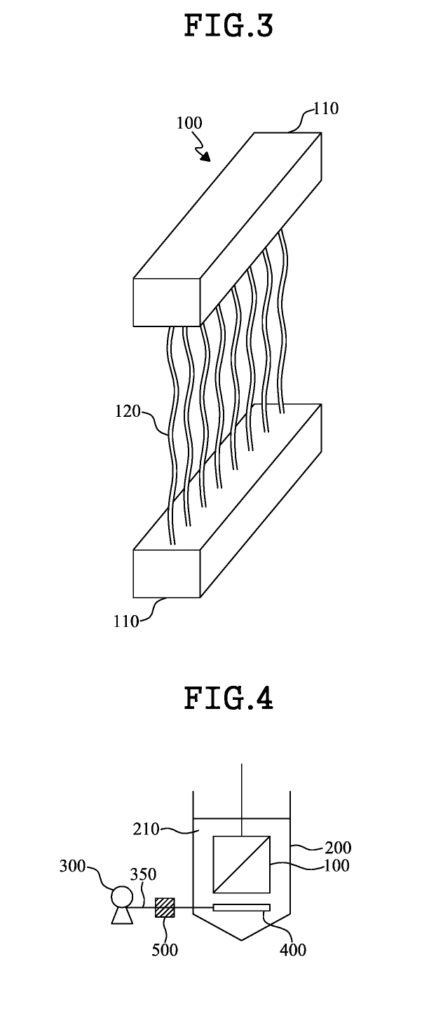

FIG. 3 is a schematic view illustrating a submerged-type hollow fiber membrane module. FIG. 4 is a schematic view illustrating a filtering system using a submerged-type hollow fiber membrane module according to the present invention.

The submerged-type hollow fiber membrane module 100 includes two headers 110, wherein a plurality of bundles of hollow fiber membranes 120 are provided between the two headers 11D. Both ends of each hollow fiber membrane 120 are potted into the respective headers 110 by the use of potting material such as polyurethane. In the headers 110, there is a water-collecting portion (not shown) which is in communication with ends of the hollow fiber membranes 120, whereby permeates permeating through the hollow fiber membrane 120 are collected in the water-collecting portion (not shown).

As shown in FIG. 4, the submerged-type hollow fiber membrane module 100 is positioned in a water-treatment tank 200. Feed water 210 to be treated is introduced into the water-treatment tank 200. Thus, the submerged-type hollow fiber membrane module 100 is submerged into the feed water 210 to be treated. Under the submerged-type hollow fiber membrane module 100, there is an aeration pipe 400 jetting air for cleaning the hollow fiber membrane 120. The air jetted via the aeration pipe 400 corresponds to the air heated to a predetermined temperature, which is supplied from an air supplying means 300. The air supplying means 300 of the present invention may be a blower or air compressor, but not necessarily. The air supplying means 300 may be formed in any shape enabling to supply the air.

The air discharged from the air supplying means 300 is supplied to the aeration pipe 400 inside the water-treatment tank 200 through a pipe 350, wherein the pipe 350 is heated by a heater 500. In the same manner as the filtering system shown in FIG. 2, air passing through the pipe 350 is also heated when the pipe 350 is heated by the heater 500. The heater 500 includes a heating wire wound on the pipe 350, but it is not limited to the heating wire. Instead of the heating wire, it is possible to provide any shape capable of heating the pipe 350. For example, the heater 500 may heat the air passing through the pipe 350 by the use of heating fluid.

The heated air is jetted to the hollow fiber membrane module 100 through the aeration pipe 400, to thereby concentratedly raise a temperature of the feed water adjacent to the hollow fiber membrane 120. Thus, a temperature difference occurs between the feed water positioned adjacent to the hollow fiber membrane 120 and the feed water positioned in the other portions, whereby the heat energy can be saved by the temperature difference.

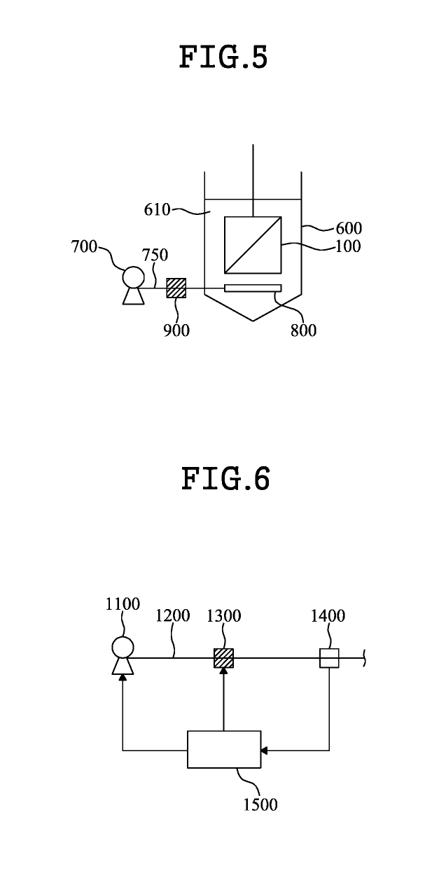

FIG. 5 illustrates a recovery cleaning of a hollow fiber membrane module by the use of filtering system according to the present invention.

As shown in FIG. 5, in order to carry out a recovery cleaning of hollow fiber membrane module 100 used in a water treatment for a predetermined time period, the hollow fiber membrane module 100 is submerged into a cleaning tank 600 filled with an acid or alkaline chemical cleaning solution 610. Inside the cleaning tank 600, there is an aeration pipe 800 jetting air. The aeration pipe 800 is positioned under the hollow fiber membrane module 100 inside the cleaning tank 600.

The air jetted via the aeration pipe 800 corresponds to the air heated to a predetermined temperature, which is supplied from an air supplying means 700. In the same manner as the other embodiments of the present invention, the air supplying means 700 may be a blower or air compressor, but not necessarily. The air supplying means 700 may be formed in any shape enabling to supply the air.

The air discharged from the air supplying means 700 is supplied to the aeration pipe 800 inside the cleaning tank 600 through a pipe 750, wherein the pipe 750 is heated by a heater 900. In this case, air passing through the pipe 750 is heated when the pipe 750 is heated by the heater 900. The heater 900 includes a heating wire wound on the pipe 750, but it is not limited to the heating wire. Instead of the heating wire, it is possible to provide any shape capable of heating the pipe 750. For example, the heater 900 may heat the air passing through the pipe 750 by the use of heating fluid.

The heated air is jetted to the hollow fiber membrane module 100 through the aeration pipe 800, to thereby concentratedly raise a temperature of the chemical cleaning solution adjacent to the hollow fiber membrane 120. Thus, a temperature difference occurs between the chemical cleaning solution positioned adjacent to the hollow fiber membrane 120 and the chemical cleaning solution positioned in the other portions, whereby the heat energy can be saved by the temperature difference.

A recovery rate of filtering membrane calculated when applying the filtering system and method according to the present invention, wherein the recovery rate is defined by the following equation, is outstandingly higher than a recovery rate of filtering membrane calculated when the unheated feed water or unheated chemical cleaning solution is supplied to the water-treatment tank or cleaning tank.

### [Equation]

Recovery rate of filtering membrane=(permeation flux after cleaning/permeation flux before cleaning)×100(%)

While maintaining the same cleaning efficiency, energy consumption in the filtering system and method according to the present invention may be reduced to about half in comparison with the case where the entirely-heated feed water or entirely-heated chemical cleaning solution is supplied to the water-treatment tank or cleaning tank.

An operation of the heaters 70, 500, 900 of the present invention shown in FIGS. 2, 4, and 5 will be explained with reference to FIG. 6. FIG. 6 is a block diagram illustrating an operation of heater according to an embodiment of the present invention.

As shown in FIG. 6, air supplied through a pipe 1200 from an air supplying means 1100 may be directly or indirectly heated by a heater 1300. Preferably, the pipe 1200 is formed of a material selected in consideration for durability, corrosion resistance, and thermal conductivity.

The heater 1300 may be controlled in various methods by a controller 1500. For example, the controller 1500 may control the heater 1300 by a cyclic heating mode of cyclically turning on/off the heater 1300, or cyclically controlling the heating intensity of heater 1300.

If the air is indirectly heated by heating the pipe 1200 through the use of heater 1300, the operation of the heater 1300 may be temporarily stopped, or the heating intensity of the heater 1300 may be lowered so that the air may be heated by the remaining heat of the pipe 1200. Thus, if the heater 1300 is controlled in the cyclic heating mode, the energy consumption is reduced without the substantial decrease of the cleaning efficiency.

In the aspect of energy reduction without the substantial decrease of the cleaning efficiency, the air supplying means 1100 may be controlled in a cyclic aeration mode by the controller 1500. That is, the controller 1500 may cyclically turn-on/off the air supplying means 1100, or may change a power intensity applied to the air supplying means 1100 cyclically. In this case, under the control of the controller 1500, the heater 1300 may operates only when the air supplying means 1100 operates.

Selectively, as shown in FIG. 6, there may be a temperature sensor 1400 which directly or indirectly senses the temperature of the air heated by the heater 1300, and transmits temperature data to the controller 1500. The controller 1500 controls the heater 1300 on the basis of the temperature data transmitted from the temperature sensor 1400. For example, if the temperature data transmitted from the temperature sensor 1400 is above a predetermined temperature, the controller 1500 stops the operation of the heater 1300, or decrease the heating intensity of the heater 1300. Accordingly, it is possible to prevent the filtering system from being damaged by overheating, or to prevent the energy waste.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A filtering system comprising:
a membrane module including a filtering membrane;
an air supplying means for cleaning the filtering membrane; and
a heater for heating air supplied from the air supplying means.

2. The filtering system according to claim 1, further comprising a controller for controlling an operation of the heater.

3. The filtering system according to claim 2, wherein the controller cyclically turns-on/off the heater.

4. The filtering system according to claim 2, wherein the controller cyclically changes a heating intensity of the heater.

5. The filtering system according to claim 2, wherein the controller controls the operation of the heater so as to make the heater operate only when the air supplying means operates.

6. The filtering system according to claim 2, further comprising a temperature sensor for sensing a temperature of heated air,
wherein the controller controls the operation of the heater on the basis of temperature data transmitted from the temperature sensor.

7. The filtering system according to claim 6, wherein the controller stops the operation of the heater or lowers the heating intensity of the heater when the temperature data transmitted from the temperature sensor is above a predetermined temperature.

8. The filtering system according to claim 1, further comprising:
a water-treatment tank including the membrane module therein;
an aeration pipe positioned under the membrane module inside the water-treatment tank; and
a pipe for guiding the air from the air supplying means to the aeration pipe,
wherein the heater heats the air passing through the pipe by heating the pipe.

9. The filtering system according to claim 1, further comprising a pipe for guiding the air from the air supplying means to the membrane module,
wherein the heater heats the air passing through the pipe by heating the pipe.

10. The filtering system according to claim 1, further comprising:
a cleaning tank for a recovery cleaning of the membrane module;
an aeration pipe positioned under the membrane module inside the cleaning tank; and
a pipe for guiding the air from the air supplying means to the cleaning tank,
wherein the heater heats the air passing through the pipe by heating the pipe.

11. The filtering system according to claim 8, wherein the heater heats the pipe by the use of heating coil or heating fluid.

12. A filtering method comprising:
performing a water treatment by the use of membrane module including a filtering membrane;
providing air for cleaning the filtering membrane;
heating the air; and
providing the heated air to the filtering membrane.

13. The filtering method according to claim 12, wherein the air heating process is cyclically repeated.

14. The filtering method according to claim 12, wherein a heating intensity is cyclically changed for the air heating process.

15. The filtering method according to claim 12, wherein the air heating process is performed only during the air providing process.

16. The filtering method according to claim 12, further comprising sensing a temperature of the heated air directly or indirectly.

17. The filtering method according to claim 16, further comprising stopping the air heating process or lowering the air heating intensity if the sensed temperature of the air is above a predetermined temperature.

18. The filtering method according to claim 12,
wherein the water treatment is performed under the circumstance that the membrane module is submerged into feed water filled in the water-treatment tank, and
wherein the air for cleaning the membrane module is supplied to the filtering membrane.

19. The filtering method according to claim 12, wherein the air for cleaning the membrane module is supplied to the inside of the membrane module through a pipe.

20. The filtering method according to claim 12, further comprising submerging the membrane module which completes the water treatment into a cleaning tank,
wherein air for cleaning the membrane module is supplied to the filtering membrane of the membrane module submerged into the cleaning tank through a pipe.

21. The filtering method according to claim 18, wherein the air heating process is performed by heating the pipe.
